(19) United States
(12) Patent Application Publication
(10) Pub. No.: US 2026/0087313 A1
(43) Pub. Date: Mar. 26, 2026

(54) APPARATUS AND METHOD FOR DETECTING DEEPFAKE MUSIC

(71) Applicant: BRAINDECK INC., Seoul (KR)

(72) Inventors: Yeo Reum JUNG, Yongin-si (KR); Young Min SEO, Seoul (KR)

(73) Assignee: BRAINDECK INC., Seoul (KR)

(21) Appl. No.: 18/929,273

(22) Filed: Oct. 28, 2024

(30) Foreign Application Priority Data
Sep. 25, 2024 (KR) 10-2024-0129928

(51) Int. Cl. G06N 3/0455; G06N 3/094; G10L 25/30; G10L 25/51

(52) U.S. Cl. CPC G06N 3/0455; G06N 3/094; G10L 25/30; G10L 25/51

(57) ABSTRACT

A deepfake music detection apparatus according to the present disclosure includes an input unit which receives audio data, a feature extracting unit which extracts sound features from the audio data, a voice separation detecting unit which acquires a voice separation probability which is a probability of performing voice separation processing on voices included in the audio data, from the sound feature, a neural vocoder detecting unit which acquires a neural vocoder probability which is a probability of generating voices included in the audio data through a neural vocoder, and a deepfake determining unit which determines whether the audio data is deepfake using the voice separation probability and the neural vocoder probability.

### CROSS-REFERENCE TO RELATED APPLICATIONS

This application claims priority to and the benefit of Korean Patent Application No. 10-2024-0129928 filed in the Korean Intellectual Property Office on Sep. 25, 2024, the entire contents of which are incorporated herein by reference.

### BACKGROUND

### Field

The present disclosure relates to an apparatus and a method for detecting deepfake music, and more particularly, to a deepfake music detecting apparatus and method which detect whether audio data including voices and accompaniment is deepfake.

### Description of the Related Art

As the artificial intelligence technology advances, the deepfake technology using it is also becoming more sophisticated day by day. The recent incident on the global streaming platform Spotify, where AI-generated songs using the voices of famous American singers Drake and The Weekend garnered significant streaming and views, clearly demonstrated the potential dangers of this technology. This shows that it goes beyond the level of a mischief or simple fraud and can cause serious copyright infringement issues.

However, research on voice-related deepfake detection is still limited, and deepfake detection methodologies for singing voices for copyright protection in the music industry are inadequate.

### SUMMARY

A technical object to be achieved by the present disclosure is to provide a deepfake music detection apparatus and method which effectively detect whether audio data including voices (vocal) and accompaniment is deepfake.

The technical object to be achieved by the present disclosure is not limited to the above-mentioned technical objects, and other technical objects, which are not mentioned above, can be clearly understood by those skilled in the art from the following descriptions.

In order to achieve the above-described technical object, according to an aspect of the present disclosure, a deepfake music detection apparatus includes an input unit which receives audio data, a feature extracting unit which extracts a sound feature from the audio data, a voice separation detecting unit which acquires a voice separation probability which is a probability of performing voice separation processing on voices included in the audio data, from the sound feature, a neural vocoder detecting unit which acquires a neural vocoder probability which is a probability of generating voices included in the audio data through a neural vocoder; and a deepfake determining unit which determines whether the audio data is deepfake using the voice separation probability and the neural vocoder probability.

The sound feature includes spectrum envelop features, temporal dynamics features, pitch and harmonic frequency features, and voice tract features.

The spectral envelope features include Mel-frequency cepstral coefficients, a spectral centroid, a spectral flatness, and spectral rolloff, the temporal dynamics features include delta and delta-delta, spectral flux, and zero crossing rate of the MFCC, the pitch and harmonic frequency characteristics include a fundamental frequency (FO), harmonic-noise ratio (HNR), and chroma features, and the vocal tract feature includes formant frequencies, formant bandwidth, jitter, and shimmer.

The voice separation detecting unit includes a variational auto encoder-generative adversarial network model and a sound separation probability calculating unit, the variational auto encoder-generative adversarial network model is configured by an encoder, a decoder, and a discriminator, the sound feature is input to the encoder to output a restored sound feature from the decoder, and the voice separation probability calculating unit calculates the voice separation probability using a restoring error between the input sound feature and the restored sound feature.

The variational auto encoder-generative adversarial network model is trained using audio data which has not undergone voice separation.

The voice separation probability calculating unit calculates a cosine similarity between the input sound feature and the restored sound feature as the voice separation probability.

The neural vocoder detecting unit includes: a voice separating unit which separates voices from the audio data; a feature extracting unit which extracts sound features from the voices; and a neural vocoder detection model which outputs the neural vocoder probability from the sound features, and the neural vocoder detection model is trained using labeled learning data including a sound feature of an original voice and a sound feature of a voice generated through the neural vocoder.

The deepfake detecting unit includes a deepfake detection model which is configured by a multilayer perceptron and outputs a deepfake probability from the voice separation probability and the neural vocoder probability, if the deepfake probability is equal to or higher than a predetermined threshold value, the audio data is determined to be deepfake, and the deepfake detection model is trained using labeled learning data including a voice separation probability and a neural vocoder probability of original audio data and a voice separation probability and a neural vocoder probability of deepfaked audio data.

In order to achieve the above-described technical object, according to another aspect of the present disclosure, a deepfake music detection method includes receiving audio data; extracting a sound feature from the audio data; acquiring a voice separation probability which is a probability of performing voice separation processing on voices included in the audio data, from the sound feature; acquiring a neural vocoder probability which is a probability of generating voices included in the audio data through a neural vocoder; and determining whether the audio data is deepfake using the voice separation probability and the neural vocoder probability.

In the acquiring of a voice separation probability, the voice separation probability is acquired using a variational auto encoder-generative adversarial network model configured by an encoder, a decoder, and a discriminator, the sound feature is input to the encoder to acquire a restored sound feature from the decoder, and the voice separation probability is calculated using a restoring error between the input sound feature and the restored sound feature.

The variational auto encoder-generative adversarial network model is trained using audio data which has not undergone voice separation.

In the acquiring of a voice separation probability, a cosine similarity between the input sound feature and the restored sound feature is calculated as the voice separation probability.

The acquiring of a neural vocoder probability includes separating voices from the audio data; extracting sound features from the voices; and acquiring the neural vocoder probability from the sound feature through a neural vocoder detection model, and the neural vocoder detection model is trained using labeled learning data including a sound feature of an original voice and a sound feature of a voice generated through the neural vocoder.

In the determining of whether to be deepfake, a deepfake detection model which is configured by a multilayer perceptron and outputs a deepfake probability from the voice separation probability and the neural vocoder probability is used, if the deepfake probability is equal to or higher than a predetermined threshold value, the audio data is determined to be deepfake, and the deepfake detection model is trained using labeled learning data including a voice separation probability and a neural vocoder probability of original audio data and a voice separation probability and a neural vocoder probability of deepfaked audio data.

According to the above-described present disclosure, it is possible to effectively detect whether audio data including voice (vocal) and accompaniment is deepfake.

Effects of the present disclosure are not limited to the above-mentioned effects, and other effects, which are not mentioned above, can be clearly understood by those skilled in the art from the following descriptions.

### BRIEF DESCRIPTION OF THE DRAWINGS

FIG. 1 illustrates a general configuration of a deepfake music generating device;

FIG. 2 illustrates a configuration of a deepfake music detection apparatus according to an exemplary embodiment of the present disclosure;

FIG. 3 illustrates a specific configuration of a voice separation detecting unit 130;

FIG. 4 illustrates a specific configuration of a neural vocoder detecting unit 140;

FIG. 5 illustrates an example of a deepfake detection model; and

FIG. 6 illustrates a flowchart of a deepfake music detection method according to an exemplary embodiment of the present disclosure.

### DETAILED DESCRIPTION OF THE EMBODIMENT

Hereinafter, exemplary embodiments of the present disclosure will be described in detail with reference to the drawings. Substantially same components in the following description and the accompanying drawings may be denoted by the same reference numerals so that a redundant description will be omitted. Further, in the description of the exemplary embodiment, if it is considered that specific description of related known configuration or function may cloud the gist of the present disclosure, the detailed description thereof will be omitted.

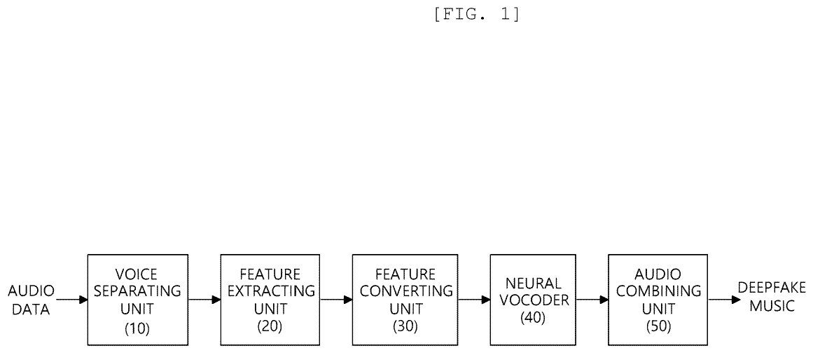

FIG. 1 illustrates a general configuration of a deepfake music generating device.

A deepfake music generating device includes a voice separating unit 10, a feature extracting unit 20, a feature converting unit 30, a neural vocoder 40, and an audio combining unit 50.

The voice separating unit 10 separates voices and accompaniment from audio data including voices (vocal) and accompaniment using an audio source separation technique. The feature extracting unit 10 extracts a sound feature from the voice. As the sound feature, mainly spectrogram and Mel spectrogram are used.

The feature converting unit 30 converts the sound feature into a sound feature of the other person using an artificial intelligence model.

The neural vocoder 40 generates a voice audio waveform from the sound feature using a neural network model.

The audio combining unit 50 combines the voice audio waveform and the accompaniment to generate a deepfake music. As known from the above description, in order to generate a deepfake music, it is required to perform a voice separation processing using the audio source separation technique and the voice audio waveform generation using the neural vocoder.

According to the present disclosure, by considering that artifacts are generated during the voice separation processing and the neural vocoder processing, it is determined whether audio data is deepfake by detecting whether a voice included in audio data is generated by the voice separation processing or the neural vocoder.

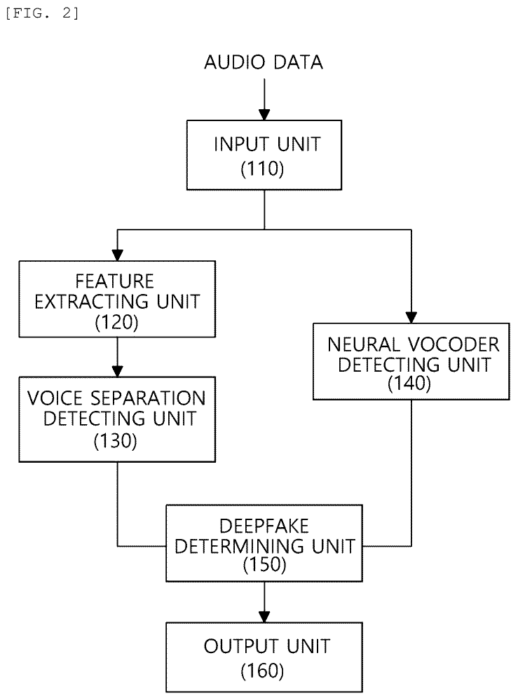

FIG. 2 illustrates a configuration of a deepfake music detection apparatus according to an exemplary embodiment of the present disclosure.

The deepfake music detection apparatus according to an exemplary embodiment of the present disclosure includes an input unit 110, a feature extracting unit 120, a voice separation detecting unit 130, a neural vocoder detecting unit 140, a deepfake determining unit 150, and an output unit 160.

The input unit 110 receives audio data. The audio data includes a voice and an accompaniment.

The feature extracting unit 120 extracts a sound feature from the audio data. The sound feature includes spectral envelope features, temporal dynamics features, pitch and harmonic features, and vocal tract features.

The spectral envelope features capture a shape and a characteristic of a frequency spectrum and senses an unnatural change in spectral distribution generated during the audio source separation or voice conversion. The spectral envelope features include Mel-frequency cepstral coefficients, a spectral centroid, a spectral flatness, and spectral rolloff. MFCC is a coefficient representing a spectral envelope in the Mel scale. The spectral centroid refers to a center of mass of spectrum. The spectral flatness indicates a degree of spread around the spectral centroid. The spectral rolloff refers to a frequency which occupies a specific percentage of a spectral energy.

The temporal dynamics features capture how spectral characteristic change over time and senses artifacts or temporal inconsistence caused by audio source separation or voice conversion. The temporal dynamics features include delta and delta-delta, spectral flux, and zero crossing rate of the MFCC. The delta of MFCC is a derivative of MFCC that captures frame-to-frame changes, while delta-delta captures the acceleration of spectral changes. The spectral flux measures how quickly the spectrum changes at every frame. The zero crossing rate refers to a rate at which a signal changes from positive to negative or from negative to positive.

Pitch and harmonic features capture features related to the fundamental frequency and harmonic structure over time and detects unnatural pitch changes or harmonic distortions during voice conversion. The pitch and harmonic frequency features include a fundamental frequency (FO), harmonic-noise ratio (HNR), and chroma features. The fundamental frequency refers to a perceived pitch of sound. The harmonic-noise ratio refers to a ratio of a harmonic wave of a signal to a noise energy. The chroma features are a 12-dimensional representation of a spectral energy where same level of pitches are mapped to one element.

A vocal tract feature captures a characteristic related to a shape of the vocal cords and detects unnatural formant change or inconsistence of a voice quality which may occur during the voice conversion. The vocal tract feature includes formant frequencies, formant bandwidth, jitter, and shimmer. The formant frequency uses F1, F2, F3, and F4 as a resonance frequency of vocal cords. The formant bandwidth represents a width of a formant peak. The jitter represents a periodic variation of the fundamental frequency. The shimmer represents change between cycles of amplitudes.

The feature extracting unit 120 vertically combines sound features extracted as described above.

The voice separation detecting unit 130 acquires a voice separation probability which is a probability of separating voice included in the audio data, from the sound feature.

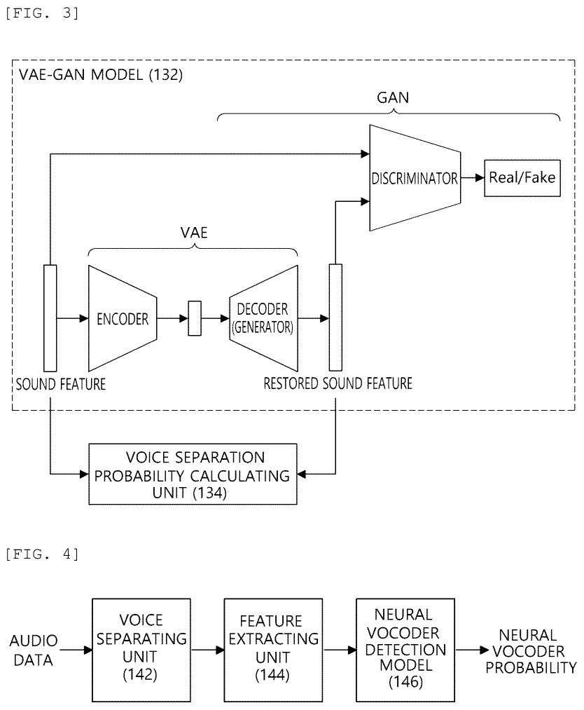

FIG. 3 illustrates a specific configuration of a voice separation detecting unit 130.

The voice separation detecting unit 130 is configured by a variational auto encoder-generative adversarial network (VAE-GAN) model 132 and a voice separation probability calculating unit 134 which calculates a voice separation probability.

The VAE-GAN model 132 is configured by an encoder, a decoder (generator), and a discriminator. The VAE-GAN model is a structure that a VAE model and a GAN model share a decoder (generator).

The encoder and the decoder configure the variational auto encoder (VAE). The variational auto encoder is a model that learns the distribution of data based on given data and generates data based on this, and is effective when trying to learn the distribution of complex data. The encoder compresses sound features to generate latent representation and the decoder restores the latent representation to output restored sound features. The encoder is a CNN-RNN based model and the CNN layer compresses the sound feature and transmits the compressed sound feature to the RNN layer to be mapped to a latent space. The variational auto encoder learns the distribution of data so that it is robust to other type of data as well as given learning data. Accordingly, when considering that the specificity of music having various types of genres, the variational auto encoder may be robust to music of untrained genre.

The decoder (generator) and the discriminator configure the generative adversarial network (GAN). The generative adversarial network is configured by a generator which is a model of generating fake data similar to real data using an artificial neural network and a discriminator which discriminates whether input data is real or fake. The discriminator outputs a probability value between 0 and 1 using a multi-layer perceptron. The discriminator discriminates whether the input sound feature is an original sound feature input to the encoder or a sound feature restored by the decoder. The discriminator of the generative adversarial network learns a method for discriminating the sound feature restored by the generator (decoder) to serve as a value of a loss function for a restoring function of the generator to enhance the learning robustness for the latent representation.

The VAE-GAN model 132 is trained using original audio data which does not undergo the voice separation processing, that is, which is not deepfake. Accordingly, in the case of the original audio data, a restoring error between the sound feature to be input to the encoder and the sound feature restored by the decoder is very small. However, in the case of the audio data which has undergone the voice separation processing, artifacts are generated during the voice separation processing so that the restoring error between the sound feature to be input to the encoder and the sound feature restored by the decoder becomes relatively large.

Accordingly, the voice separation probability calculating unit 134 calculates a voice separation probability using a restoring error between the sound feature input to the encoder and the sound feature restored by the decoder. Specifically, the voice separation probability calculating unit 134 calculates a cosine similarity between the sound feature input to the encoder and the sound feature restored by the decoder as the voice separation probability. The cosine similarity is calculated by the following Equation.

$$similarity = cos ( θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} \qquad [ Equation 1 ]$$

Here, A indicates a sound feature input to the encoder and B indicates a sound feature restored by the decoder.

Referring to FIG. 2 again, the neural vocoder detecting unit 140 acquires a neural vocoder probability which is a probability of generating a sound included in the audio data through the neural vocoder.

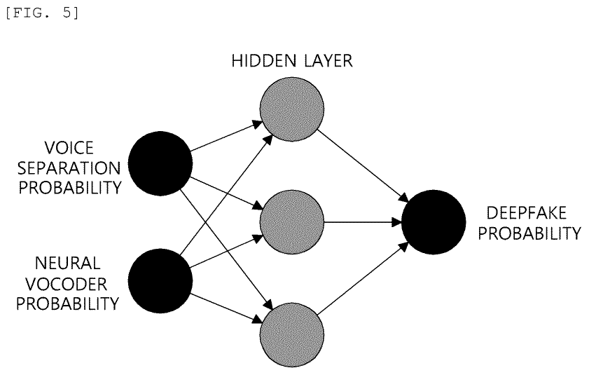

FIG. 4 illustrates a specific configuration of a neural vocoder detecting unit 140.

The neural vocoder detecting unit 140 includes a voice separating unit 142, a feature extracting unit 144, and a neural vocoder detecting model 146.

The voice separating unit 142 separates voices from audio data using an audio source separation technique.

The feature extracting unit 144 extracts sound features from the voices. The sound features extracted by the feature extracting unit 144 is the same as the above-described feature extracting unit 140 so that a detailed description will be omitted.

The neural vocoder detection model 146 outputs a neural vocoder probability which is a probability of generating a voice included in the audio data from the sound feature through the neural vocoder. The neural vocoder detection model 146 is a CNN model and is trained using labeled learning data including a sound feature of an original voice and a sound feature of a voice generated through the neural vocoder. That is, learning data labeled with the sound feature of an original voice and a sound feature of a voice generated through the neural vocoder is collected and the neural vocoder detection model 146 is trained with the collected learning data.

Referring to FIG. 2 again, the deepfake determining unit 150 determines whether the audio data is a deepfake using a voice separation probability from the voice separation detecting unit 130 and the neural vocoder probability from the neural vocoder detecting unit 140.

The deepfake determining unit 150 is configured by a multilayer perceptron and includes a deepfake detection model which outputs a deepfake probability from the voice separation probability and the neural vocoder probability.

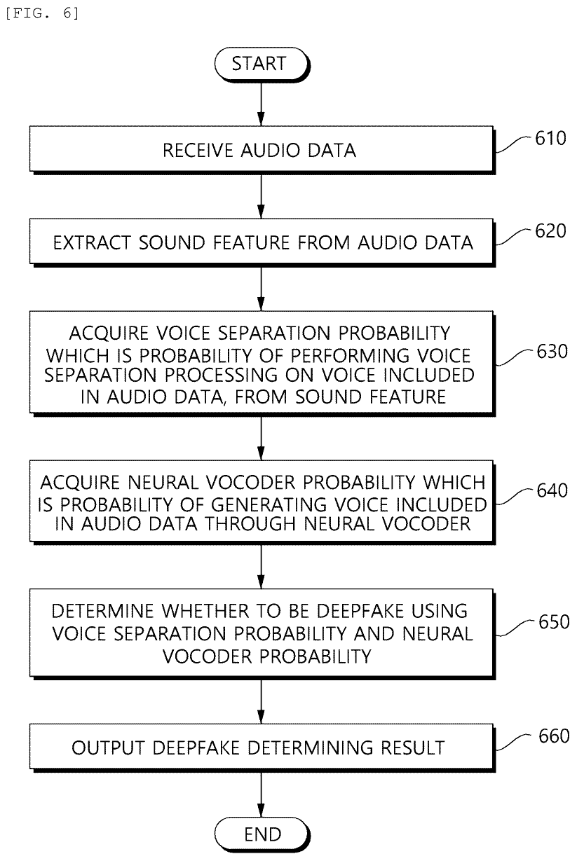

FIG. 5 illustrates an example of a deepfake detection model. The deepfake detection model receives the voice separation probability and the neural vocoder probability through an input layer and passes through a hidden layer to output a deepfake probability through an output layer. The deepfake detection model is trained using labeled learning data including a voice separation probability and a neural vocoder probability of original audio data and a voice separation probability and a neural vocoder probability of deepfaked audio data. That is, learning data labeled with the voice separation probability and the neural vocoder probability of original audio data and the voice separation probability and the neural vocoder probability of deepfaked audio data is collected and the deepfake detection model is trained with the collected learning data. The deepfake detection model receives the voice separation probability and the neural vocoder probability and is trained using a binary cross entropy loss function. The deepfake detection model outputs a probability between 0 and 1 using a sigmoid function and performs classification based on a predetermined threshold value to update the loss function.

If the deepfake probability output through the deepfake detection model is equal to or higher than the predetermined threshold value, the deepfake determining unit 150 determines that the audio data is deepfake.

The output unit 160 displays the deepfake determining result of the deepfake determining unit 150 together with the deepfake probability.

FIG. 6 illustrates a flowchart of a deepfake music detection method according to an exemplary embodiment of the present disclosure. The deepfake music detection method according to the exemplary embodiment is configured by steps processed in the above-described deepfake music detection apparatus. Accordingly, even though it is omitted below, the above-described contents about the deepfake music detection apparatus are also applied to the deepfake music detection method according to the exemplary embodiment.

In step 610, the input unit 110 receives audio data including voices and accompaniment.

In step 620, the feature extracting unit 120 extracts a sound feature from the audio data.

In step 630, the voice separation detecting unit 130 acquires a voice separation probability which is a probability of separating voice included in the audio data, from the sound feature.

In step 630, the voice separation detecting unit 130 acquires a voice separation probability using a variational auto encoder-generative adversarial network model configured by an encoder, a decoder, and a discriminator. Specifically, the voice separation detecting unit 130 inputs a sound feature to the encoder and acquires a restored sound feature from the decoder and calculates a voice separation probability using a restoring error between the sound feature input to the encoder and the restored sound feature. The variational auto encoder-generative adversarial network model is trained using audio data which has not undergone voice separation. The voice separation detecting unit 130 calculates a cosine similarity between the sound feature input to the encoder and the restored sound feature as the voice separation probability.

In step 640, the neural vocoder detecting unit 140 acquires a neural vocoder probability which is a probability of generating a sound included in the audio data through the neural vocoder.

The step 640 includes a step of separating voices from audio data, a step of extracting sound features from the voice, and a step of acquiring the neural vocoder probability from the sound features through the neural vocoder detection model. Here, the neural vocoder detection model is trained using labeled learning data including a sound feature of an original voice and a sound feature of a voice generated through the neural vocoder.

In step 650, the deepfake determining unit 150 determines whether the audio data is deepfake using the voice separation probability and the neural vocoder probability. The deepfake determining unit 150 is configured by a multilayer perceptron and uses a deepfake detection model which outputs a deepfake probability from the voice separation probability and the neural vocoder probability to determine that the audio data is deepfake if the deepfake probability is equal to or higher than a predetermined threshold value. Here, the deepfake detection model is trained using labeled learning data including a voice separation probability and a neural vocoder probability of original audio data and a voice separation probability and a neural vocoder probability of deepfaked audio data.

In step 660, the output unit 160 displays the deepfake determining result together with the deepfake probability.

The apparatus according to the exemplary embodiments of the present disclosure includes a processor, a permanent storage which stores and executes program data such as a memory or a disk driver, a communication port which communicates with the external device, and a user interface such as a key or a button. Methods which are implemented by a software module or an algorithm may be computer readable codes or program instructions which are executable on the processor and stored on a computer readable recording medium. Here, the computer readable recording medium may include a magnetic storage medium such as a read only memory (ROM), a random access memory (RAM), a floppy disk, and hard disk and an optical reading medium such as CD-ROM or digital versatile disc (DVD). The computer readable recording medium is distributed in computer systems connected through a network so that computer readable code is stored therein and executed in a distributed manner. The medium is readable by the computer, is stored in the memory, and is executed in the processor.

Exemplary embodiments of the present disclosure may be represented with functional block configurations and various processing steps. The functional blocks may be implemented by various numbers of hardware and/or software configurations which execute specific functions. For example, the exemplary embodiment may employ integrated circuit configurations such as a memory, a processing, a logic, or a look-up table in which various functions are executable by the control of one or more microprocessors or the other control devices. Similar to execution of the components of the present disclosure with software programming or software elements, the exemplary embodiment may be implemented by programming or scripting languages such as C, C++, Java, assembler including various algorithms implemented by a combination of data structures, processes, routines, or other program configurations. The functional aspects may be implemented by an algorithm executed in one or more processors. Further, the exemplary embodiment may employ the related art for the electronic environment setting, signal processing and/or data processing. The terms such as “mechanism”, “element”, “unit”, and “configuration” are broadly used and are not limited to mechanical and physical configurations. The terms may include meaning of a series of routines of a software in association with the processor.

Specific executions described in the exemplary embodiments are examples, so that the range of the exemplary embodiment is not limited by any way. For simplicity of the specification, the description of another functional aspects of the electronic configurations, control systems, software, and the systems of the related art may be omitted. Further, connections of components illustrated in the drawing with lines or connection members illustrate functional connection and/or physical or circuit connections. Therefore, in the actual apparatus, it is replaceable or represented as additional various functional connections, physical connections, or circuit connections. Unless specifically stated as “essential”, “importantly”, it may not be an essential configuration to apply the present disclosure.

For now, the present disclosure has been described with reference to the exemplary embodiments. It is understood to those skilled in the art that the present disclosure may be implemented as a modified form without departing from an essential characteristic of the present disclosure. Therefore, the disclosed exemplary embodiments may be considered by way of illustration rather than limitation. The scope of the present disclosure is presented not in the above description but in the claims and it may be interpreted that all differences within an equivalent range thereto may be included in the present disclosure.

What is claimed is:

1. A deepfake music detection apparatus, comprising:
an input unit which receives audio data;
a feature extracting unit which extracts a sound feature from the audio data;
a voice separation detecting unit which acquires a voice separation probability which is a probability of performing voice separation processing on voices included in the audio data, from the sound feature;
a neural vocoder detecting unit which acquires a neural vocoder probability which is a probability of generating voices included in the audio data through a neural vocoder; and
a deepfake determining unit which determines whether the audio data is deepfake using the voice separation probability and the neural vocoder probability.

2. The deepfake music detection apparatus according to claim 1, wherein the sound feature includes spectral envelope features, temporal dynamics features, pitch and harmonic features, and vocal tract features.

3. The deepfake music detection apparatus according to claim 2, wherein the spectral envelope features include Mel-frequency cepstral coefficients, a spectral centroid, a spectral flatness, and spectral rolloff, the temporal dynamics features include delta and delta-delta, spectral flux, and zero crossing rate of the MFCC, the pitch and harmonic frequency characteristics include a fundamental frequency (FO), harmonic-noise ratio (HNR), and chroma features, and the vocal tract feature includes formant frequencies, formant bandwidth, jitter, and shimmer.

4. The deepfake music detection apparatus according to claim 1, wherein the voice separation detecting unit includes a variational auto encoder-generative adversarial network model and a voice separation probability calculating unit,
the variational auto encoder-generative adversarial network model is configured by an encoder, a decoder, and a discriminator,
the sound feature is input to the encoder to output a restored sound feature from the decoder, and
the voice separation probability calculating unit calculates the voice separation probability using a restoring error between the input sound feature and the restored sound feature.

5. The deepfake music detection apparatus according to claim 4, wherein the variational auto encoder-generative adversarial network model is trained using audio data which has not undergone voice separation.

6. The deepfake music detection apparatus according to claim 4, wherein the voice separation probability calculating unit calculates a cosine similarity between the input sound feature and the restored sound feature as the voice separation probability.

7. The deepfake music detection apparatus according to claim 1, wherein the neural vocoder detecting unit includes:
a voice separating unit which separates voices from the audio data;
a feature extracting unit which extracts sound features from the voices; and
a neural vocoder detection model which outputs the neural vocoder probability from the sound features, and
the neural vocoder detection model is trained using labeled learning data including a sound feature of an original voice and a sound feature of a voice generated through the neural vocoder.

8. The deepfake music detection apparatus according to claim 1, wherein the deepfake determining unit includes a deepfake detection model which is configured by a multilayer perceptron and outputs a deepfake probability from the voice separation probability and the neural vocoder probability,
if the deepfake probability is equal to or higher than a predetermined threshold value, determines the audio data to be deepfake, and
the deepfake detection model is trained using labeled learning data including a voice separation probability and a neural vocoder probability of original audio data and a voice separation probability and a neural vocoder probability of deepfaked audio data.

9. A deepfake music detection method, comprising:
receiving audio data;
extracting a sound feature from the audio data;
acquiring a voice separation probability which is a probability of performing voice separation processing on voices included in the audio data, from the sound feature;
acquiring a neural vocoder probability which is a probability of generating voices included in the audio data through a neural vocoder; and
determining whether the audio data is deepfake using the voice separation probability and the neural vocoder probability.

10. The deepfake music detection method according to claim 9, wherein the sound feature includes spectral envelope features, temporal dynamics features, pitch and harmonic features, and vocal tract features.

11. The deepfake music detection method according to claim 10, wherein the spectral envelope features include Mel-frequency cepstral coefficients, a spectral centroid, a spectral flatness, and spectral rolloff, the temporal dynamics features include delta and delta-delta, spectral flux, and zero crossing rate of the MFCC, the pitch and harmonic frequency characteristics include a fundamental frequency (FO), harmonic-noise ratio (HNR), and chroma features, and the vocal tract feature includes formant frequencies, formant bandwidth, jitter, and shimmer.

12. The deepfake music detection method according to claim 9, wherein in the acquiring of a voice separation probability, the voice separation probability is acquired using a variational auto encoder-generative adversarial network model configured by an encoder, a decoder, and a discriminator, the sound feature is input to the encoder to acquire a restored sound feature from the decoder, and the voice separation probability is calculated using a restoring error between the input sound feature and the restored sound feature.

13. The deepfake music detection method according to claim 12, wherein the variational auto encoder-generative adversarial network model is trained using audio data which has not undergone voice separation.

14. The deepfake music detection method according to claim 12, wherein in the acquiring of a voice separation probability, a cosine similarity between the input sound feature and the restored sound feature is calculated as the voice separation probability.

15. The deepfake music detection method according to claim 9, wherein the acquiring of a neural vocoder probability includes:
separating voices from the audio data;
extracting sound features from the voices; and
acquiring the neural vocoder probability from the sound features through a neural vocoder detection model, and
the neural vocoder detection model is trained using labeled learning data including a sound feature of an original voice and a sound feature of a voice generated through the neural vocoder.

16. The deepfake music detection method according to claim 9, wherein in the determining of whether to be deepfake, a deepfake detection model which is configured by a multilayer perceptron and outputs a deepfake probability from the voice separation probability and the neural vocoder probability is used,
if the deepfake probability is equal to or higher than a predetermined threshold value, the audio data is determined to be deepfake, and
the deepfake detection model is trained using labeled learning data including a voice separation probability and a neural vocoder probability of original audio data and a voice separation probability and a neural vocoder probability of deepfaked audio data.
